(19) United States
(12) Patent Application Publication
(10) Pub. No.: US 2016/0197858 A1
(43) Pub. Date: Jul. 7, 2016

(54) METHODS, SYSTEMS AND RECORDING MEDIUMS FOR PROVIDING MESSENGER SERVICE WITH USER CUSTOMIZABLE TEMPLATES

(71) Applicant: LINE Corporation, Tokyo (JP)

(72) Inventor: Ki Yong CHA, Seongnam-si (KR)

(21) Appl. No.: 14/838,808

(22) Filed: Aug. 28, 2015

(30) Foreign Application Priority Data
Jan. 2, 2015 (KR) 10-2015-0000165

(51) Int. Cl. H04L 12/58; G06F 3/0482; G06T 11/60; G06F 3/0481; G06F 17/28; G06F 3/0484; G06F 17/24

(52) U.S. Cl. CPC H04L 51/04; G06F 3/04842; G06F 3/0482; G06F 17/248; G06F 3/04817; G06F 17/289; G06T 11/60

(57) ABSTRACT

In a messenger service method for implementing communications between a first terminal and a second terminal, one of a plurality of templates is selected at the first terminal, and text is received from a user. The received text is combined with the selected one of the plurality of templates to generate a modified template including the received text, and the modified template is displayed. The modified template is then transmitted to the second terminal.

### CROSS-REFERENCE TO RELATED APPLICATION(S)

This application claims priority under 35 U.S.C. §119 to Korean Patent Application No. 10-2015-0000165 filed Jan. 2, 2015, in the Korean Intellectual Property Office, the entire contents of which are incorporated herein by reference.

### BACKGROUND

1. Field

One or more example embodiments of inventive concepts described herein relate to technology for controlling messenger services capable of providing a template that a user wants.

2. Description of Related Art

A related art messenger is capable of sending and receiving messages or data in real time, and may allow a user to register a conversation partner on a messenger and to exchange messages with a conversation partner of a conversation partner list.

Nowadays, messengers are widely used in mobile environments on mobile communication terminals as well as personal computers. Disclosed in the KR patent publication No. 2002-0074303 are, for example, a mobile messenger service system and method of a portable terminal using a wireless communication network configured to allow a messenger service to be provided between mobile messengers installed on portable terminals.

The messenger service may be provided between already known friends or acquaintances and may be used to share mainly private conversations or a variety of information. Friends in a chat room may express their current feeling and situation in various methods such as using an image of an emoticon as well as text. For example, friends in a chat room may express their current status by changing a speech bubble shape or using an emoticon having a happy face.

A template such as an image of the speech bubble shape and the emoticon may include only basic text which is already fixed. Accordingly, a user may like an image of the template, but may dislike a text of the template that does not fit in with his/her current feeling state. For this reason, a user may reluctantly send an image, to which awkward text not fitting the current situation is applied, to users, or may take a lot of time to search for a template having desired text and image.

### SUMMARY

One or more example embodiments of inventive concepts are directed to methods, systems and/or record mediums, which combine text a user wants with an image of a template and provide the combined (or modified) template, when a user likes the image of the template, but dislikes a text applied to the template.

At least one example embodiment provides a messenger service method for implementing communications between a first terminal and a second terminal, the messenger service method comprising: selecting one of a plurality of templates at the first terminal; receiving text from a user of the first terminal; combining the received text with the selected one of the plurality of templates to generate a modified template including the received text; displaying the modified template; and transmitting the modified template to the second terminal.

At least one other example embodiment provides a non-transitory computer-readable storage medium including computer-executable instructions that, when executed, cause a computer system to provide a messenger service method for implementing communications between a first terminal and a second terminal, the messenger service method comprising: selecting one of a plurality of templates at the first terminal; receiving text from a user of the first terminal; combining the received text with the selected one of the plurality of templates to generate a modified template including the received text; displaying the modified template; and transmitting the modified template to the second terminal.

According to at least some example embodiments, the method may further include transmitting the modified template to a third terminal in response to receiving confirmation, from the user, that the modified template should be transmitted to the third terminal.

The transmitting may include transmitting, to the second terminal, an identifier identifying the received text and the selected one of the plurality of templates.

The selected one of the plurality of templates may include at least one of an emoticon used in the messenger service, an image of a sticker shape, and an image of a speech bubble shape.

According to at least some example embodiments, the method may further include: automatically translating the received text combined with the selected one of the plurality of templates into a language of a country to which a user of the second terminal belongs; and wherein the combining combines the selected one of the plurality templates with the translated text to generate the modified template.

The combining may include changing a basic text portion of the selected one of the plurality of templates into the received text from the user, while maintaining an image portion of the selected one of the plurality of templates, to generate the modified template.

The method may further include changing at least one of the received text and the selected one of the plurality of templates, which are displayed as the modified template.

The method may further include displaying, at the second terminal, the modified template including the received text.

The method may further include: involving the second terminal in a chat room; and providing one or more of the plurality of templates stored at the first terminal to the user in advance of the selecting the one or more of the plurality of templates.

At least one other example embodiment provides a messenger service system for implementing communications between a first terminal and a second terminal, the messenger service system comprising: a memory having computer-readable instructions stored therein; and at least one processor. The at least one processor configured to execute the computer-readable instructions to: generate a modified template by combining text received from a user of the first terminal with a template selected from among a plurality of templates by the user of the first terminal; and transmit the modified template to the second terminal.

According to at least some example embodiments, the at least one processor may be further configured to provide the messenger service to involve the second terminal in a chat room, and to provide one or more of a plurality of stored templates stored at the first terminal to the user of the first terminal prior to selection of the template by the user of the first terminal.

The at least one processor may be further configured to transmit the modified template to a third terminal in response to receiving confirmation, from the user of the first terminal, that the modified template should be transmitted to the third terminal.

The at least one processor may be further configured to transmit, to the second terminal, an identifier identifying the received text and the selected template.

The selected template may include at least one of an emoticon used in the messenger service, an image of a sticker shape, and an image of a speech bubble shape.

The at least one processor may be further configured to: automatically translate the received text combined with the selected template into a language of a country to which a user of the second terminal belongs; and combine the selected template with the translated text to generate the modified template.

The at least one processor may be further configured to change a basic text portion of the selected template into the received text from the user, while maintaining an image portion of the selected template, to generate the modified template.

The at least one processor is further configured to: display the modified template at the first terminal; and change at least one of the selected template and the received text, which are displayed as the modified template.

### BRIEF DESCRIPTION OF THE FIGURES

Inventive concepts will become apparent from the following description of the figures, wherein like reference numerals refer to like parts throughout the various figures unless otherwise specified, and wherein:

FIG. 1 is a diagram schematically illustrating a relationship between a service server and a user, according to an example embodiment of inventive concepts;

FIG. 2 is a block diagram illustrating an example internal configuration of a messenger service system, according to an example embodiment of inventive concepts;

FIG. 3 is a flow chart illustrating a messenger service method according to an example embodiment of inventive concepts;

FIG. 4 is a diagram illustrating an example template used in a messenger service, according to an example embodiment of inventive concepts;

FIG. 5 is a flow chart for describing an example operation for providing a new template by combining a template image a user wants with a text the user inputs, according to an example embodiment of inventive concepts;

FIGS. 6 to 8 are diagrams illustrating example screens displayed in a user terminal for describing an example operation for providing a new template, according to an example embodiment of inventive concepts;

FIGS. 9 and 10 are diagrams illustrating example screens provided for describing an example operation for providing an automatic language translation function when generating a new template, according to an example embodiment of inventive concepts; and

FIG. 11 is a block diagram schematically illustrating an example internal configuration of a computer system according to an example embodiment of inventive concepts.

### DETAILED DESCRIPTION

Example embodiments will be described in detail with reference to the accompanying drawings. Inventive concepts, however, may be embodied in various different forms, and should not be construed as being limited only to the illustrated embodiments. Rather, these embodiments are provided as examples so that this disclosure will be thorough and complete, and will fully convey the concept of inventive concepts to those skilled in the art. Accordingly, known processes, elements, and techniques are not described with respect to some of the embodiments of inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Example embodiments of inventive concepts described herein relate to messenger services, including both PC-based messengers and mobile messengers used in mobile devices, such as smart-phones. More particularly, one or more example embodiments of inventive concepts may relate to messenger service providing methods, systems, and/or record mediums, which revise basic text described on a template image into text a user wants, and provide the revised template.

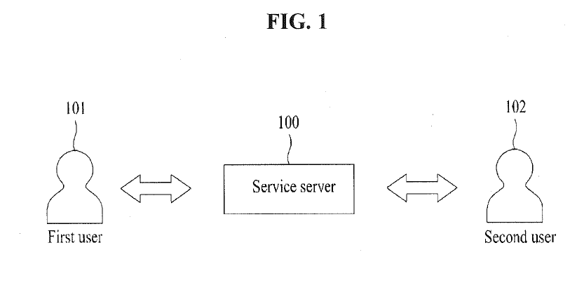

FIG. 1 is a diagram schematically illustrating a relationship between a service server and a user, according to an example embodiment of inventive concepts. FIG. 1 may illustrate a first user 101, at least one second user 102 participating in a conversation with the first user 101, and a service server 100. The first user 101 and the at least one second user 102 may substantially denote a user terminal, which each user uses. In FIG. 1, arrows may mean that data is transmitted and received between the user terminals and the service server 100 using a wired and/or wireless network.

A user terminal may refer to all terminal devices, capable of installing and executing a messenger service-dedicated application (hereinafter referred to as “messenger app”) associated with the service server 100, such as a personal computer (PC), a laptop computer, a smart phone, a tablet, a wearable computer, and the like. Here, the user terminal may perform operations of overall services such as configuring a service screen, inputting data, transmitting and receiving data, and storing data under control of the messenger app.

The service server 100 may act as a messenger platform, which provides a messenger service with respect to a client. In other words, for example, the service server 100 may be a system that provides a messenger service allowing data to be exchanged between the users 101 and 102. The messenger app may basically include a function for transmitting text written by a user, a function for transmitting a multimedia content (e.g., voice, photograph, and video), a message alarm function, a schedule function, and the like. Especially, the messenger app according to at least one example embodiment of inventive concepts may include a function which combines a template image, which a user selects, from among template images already downloaded with text a user inputs, generates a new template, and provides the new template. The messenger app may be implemented to be used in mobile environments as well as PC environments, and may be implemented with a program that is independently operated or an in-app shape of a specific application to operate on the specific application.

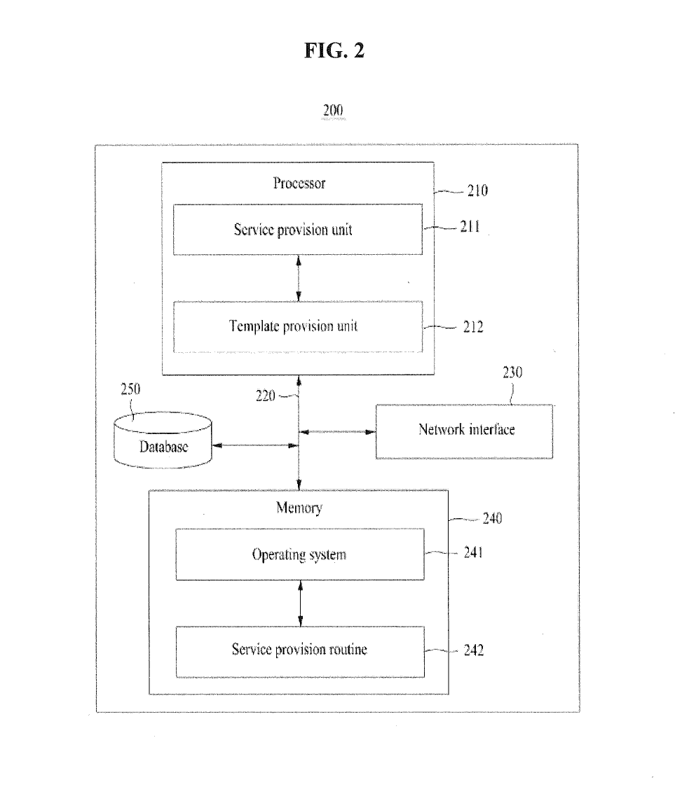

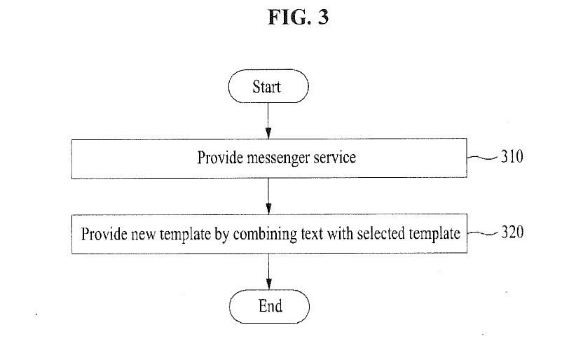

FIG. 2 is a block diagram illustrating an example internal configuration of a messenger service system, according to an example embodiment of inventive concepts. FIG. 3 is a flow chart illustrating a messenger service method according to an example embodiment of inventive concepts.

A messenger service system 200 according to an example embodiment of inventive concepts may act as a service server, may be an application having an in-app shape in a user terminal, may control a user terminal through an application installed in the user terminal, and may provide a messenger service to the user terminal through a wired and/or wireless network.

A messenger service system 200, according to one or more example embodiments of inventive concepts, may include a processor 210, a bus 220, a network interface 230, a memory 240, and database 250. The memory 240 may include an operating system 241 and a service provision routine 242. The processor 210 may include a service provision unit 211 and a template provision unit 212. In other embodiments, the messenger service system 200 may include components of which the number is more than that of FIG. 2.

The memory 240 may be a computer-readable recording medium and may include a random access memory (RAM), a read only memory (ROM), and a permanent mass storage device such as a disk drive. Stored in the memory 240 is program code for the operating system 241 and the service provision routine 242. Such software components may be loaded from a computer-readable recording medium, which is independent of the memory 240, using drive mechanism (not illustrated). The computer-readable recording medium independent of the memory 240 may include a computer-readable recording medium, such as a floppy drive, a disk, a tape, a DVD/CD-ROM drive, a memory card, or the like. In at least some other example embodiments, software components may be loaded on the memory 240 through the network interface 230, not the computer-readable recording medium.

The bus 220 may enable communication and data transmission to be performed between components of the messenger service system 200. The bus 220 may be implemented using a high-speed serial bus, a parallel bus, a storage area network (SAN), and/or any other appropriate communication technology.

The network interface 230 may be a computer hardware component for connecting the messenger service system 200 to a computer network. The network interface 230 may connect the messenger service system 200 to a computer network through wired and/or wireless connection.

The database 250 may store and retain all information required to provide a messenger service. Here, the database 250 may include a buddy list registered in a messenger, messages and data (e.g., photographs, videos, voice, and the like) sent and received through a messenger, various logs, and the like. In particular, for example, the database 250 may include template information (e.g., an emoticon, an item, an image of a sticker shape, an image of a speech bubble shape, an animation of an action shape, a font style, and the like). In the example embodiment shown in FIG. 2, the database 250 is illustrated as being implemented in the messenger service system 200. However, the scope and spirit of inventive concepts should not be limited thereto. For example, the database 250 may be omitted according to a system implementation manner and/or environment, or the whole or a portion of the database 250 may be implemented with external database constructed on a separate other system.

The processor 210 may process an instruction of a computer program by performing a basic arithmetic operation, a logic operation, and an input/output operation of the messenger service system 200. The memory 240 or the network interface 230 may provide the instruction to the processor 210 through the bus 220. The processor 210 may be configured to execute program code for the service provision unit 211 and the template provision unit 212. The program code may be stored at a recording device such as the memory 240.

The aforementioned messenger service system 200 may be implemented on a terminal of a user who uses (e.g., directly uses) a messenger service. The messenger service system 200 may be interlocked with a service server in a client-server environment, and may combine text a user inputs with a template image, such as a speech bubble, the user wants, thereby making it possible to provide the combined results.

The service provision unit 211 and the template provision unit 212 may be configured to perform steps 310 and 320 in FIG. 3.

Referring to FIG. 3, in step 310 the service provision unit 211 may provide a messenger service to user terminals, which download and execute a messenger app.

For example, in a chat room formed between users registered in advance, the service provision unit 211 may share information and data between users participating in the chat room, or may provide a messenger service such as sending or receiving a message. The messenger app may form an interface for providing a messenger service between users participating in the chat room. For example, the messenger app may form an interface for transmitting or receiving information, data, and messages between a user terminal of each user and a server. Moreover, users participating in the chat room may be provided with the messenger service in different areas or different countries through a wired and/or wireless network.

When having a talk in a chat room, several users may agree with conversation contents of one or more other users using a template, or may express their feeling status such as happiness, sorrow, love, joy, etc., using a template.

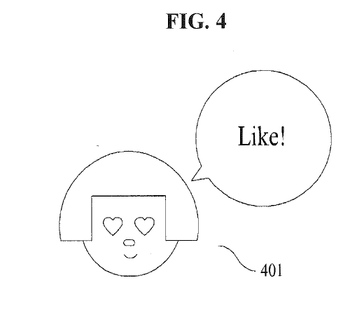

For example, referring to FIG. 4, when having a happy emotion or agreeing with conversation contents of other user, a user may select a template in which a text of “Like” with a character image of a happy face is written, thereby making it possible to provide the selected template 401 to a chat room.

The template provision unit 212 may display a new template to users by combining an image of the selected template with text a user wants. The template provision unit 212 may also display the template 401, in which basic text is written, to users in a chat room. Here, the template may include an emoticon, an item, an image of a speech bubble shape, an image of a sticker shape, etc.

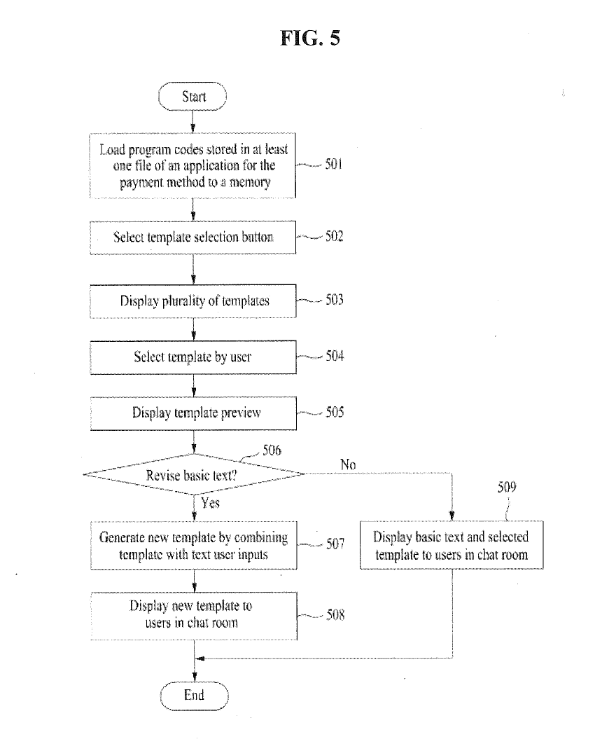

Referring back to FIG. 3, in step 320 when the messenger app is executed, a plurality of templates basically provided may be displayed at a user terminal. Then, the template provision unit 212 may generate a new template by combining user-inputted text with a template selected by a user from among a plurality of templates. Moreover, the user may provide the generated template to other users in a chat room. A more detailed discussion of an example embodiment of an operation for providing a new template will be described below with reference to FIG. 5.

FIG. 5 is a flow chart for describing an example embodiment of an operation for providing a new template by combining a template image, which a user wants, with text the user inputs. In FIG. 5, respective steps 501 to 509 may be performed by the service provision unit 211 and the template provision unit 212 shown in FIG. 2.

In FIG. 5, it may be assumed that the user exchanges information, data, and messages with one or more other users such as friends registered in advance, colleagues, and alumnus in an established chat room. For example, in FIG. 5, it may be described that a new template is generated using a template including an image of a speech bubble shape and text. However, this is only an example embodiment of inventive concepts. In addition to the speech bubble shape, a template, such as a sticker shape, an emoticon, and an animation of an action shape, may be selected and used to generate a new template.

In step 501, the processor 210 may load program codes stored in at least one file of an application for the messenger service method to a memory (e.g., the memory 240). For example, the at least one file of the messenger application may be provided from file distribution server through a network and be installed the messenger service system 200. When the application is executed in the messenger service system 200, the processor 210 may load the program codes (or instructions) from the at least one file to memory.

Each of the block map service provision unit 211 and the template provision unit 212 may be configured to execute a corresponding part of the program codes (or instructions) in the memory to process steps 502 and 509.

In step 502 user terminal of a user may execute messenger application, and the user terminal may form user interface for the messenger service to the user. The user interface includes interface for user selection, display window, transmit and receive data, etc. For example, the user selection interface includes interface for button selection, text modification, template modification, etc. The display interface includes interface for displaying a chat window, displaying a template list window, displaying preview window etc. The user who wants to use a new template may select a template selection button displayed in a chat room.

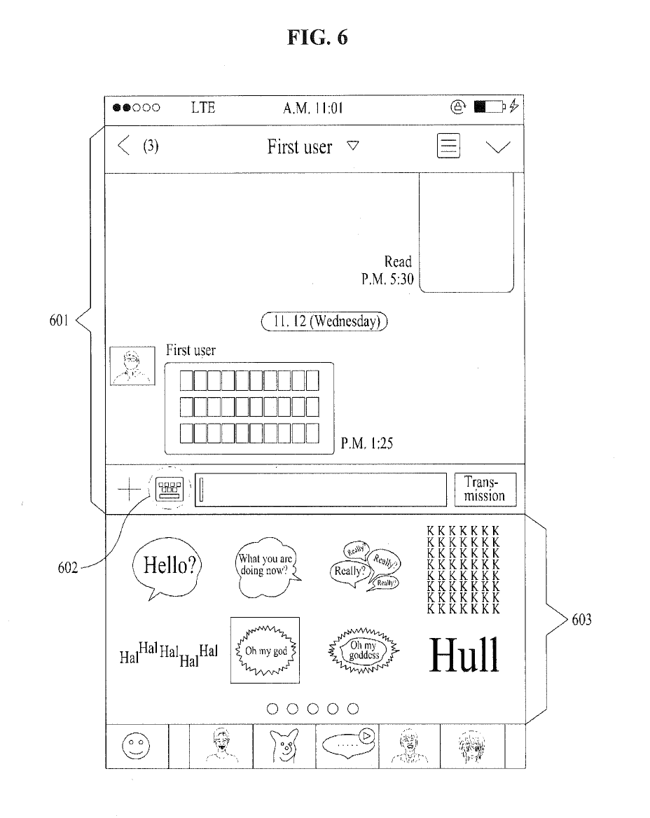

For example, referring to FIG. 6, conversation contents between users participating in an established chat room may be displayed in a chat window 601. A template selection button 602 for selecting and revising a template basically provided or purchasing a pay template may be located at the bottom of the chat window 601.

In step 503, a plurality of templates may be displayed when a user selects the template selection button 602.

In one or more example embodiments, templates which are downloaded from a server through a messenger app in advance may be stored in the database 250. For example, templates associated with an animal character such as a cat and a rabbit, templates associated with an anniversary such as a birthday and Christmas, and templates associated with a celebrity or a specific theme may be stored in the database 250. Here, when the template selection button 602 is selected, a plurality of templates stored in the database 250 may be displayed in a template list window 603 located at the bottom of the chat window 601. For example, the plurality of templates may include at least one basic template provided for free and a pay template, which is purchased or presented. The plurality of templates may be displayed to a user selecting the template selection button 602 to apply a new template, but not to other users in a chat room.

In step 504, a template provision unit 212 may select one template, which a user wants, from among a plurality of templates displayed in the template list window 603 based on a selection of a user.

In step 505, the template provision unit 212 may display the selected template to a user through a preview function.

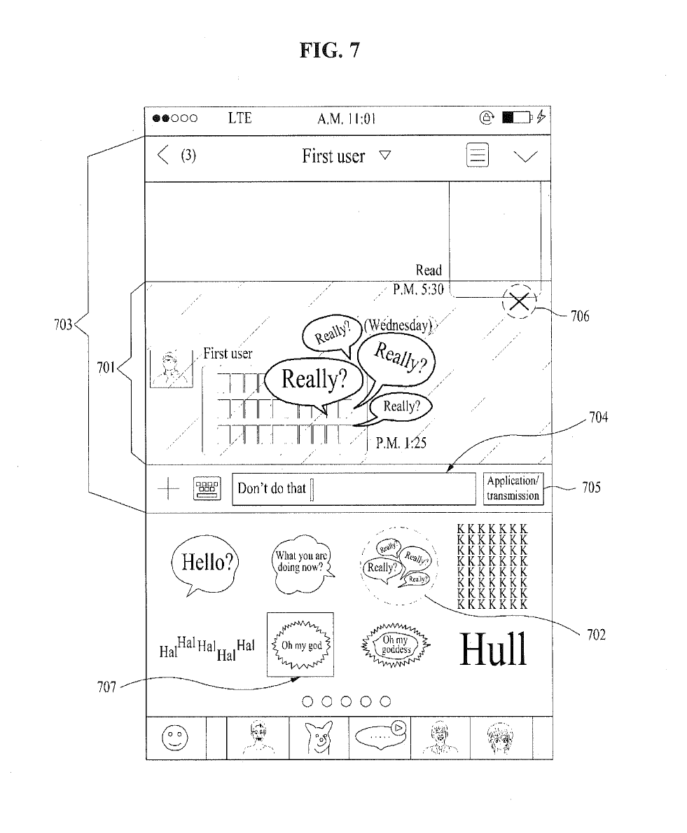

For example, referring to FIG. 7, the template provision unit 212 may display a first template 702, which a user selects, in a preview window 701. Here, the template displayed in the preview window 701 may be a template, to which basic text provided when the template is downloaded is applied, not text a user inputs. For example, when there is downloaded the first template 702 in which “Really?” is included in a speech bubble as basic text, the first template 702 of a speech bubble shape in which the basic text “Really?” is included may be displayed on the preview window 701. Here, the template provision unit 212 may display the chat window 703 by overlapping a portion of the translucent preview window 701, such as half of the chat window 703, or a specific percent thereof, with the chat window 703. The preview window 701 may be displayed to only a user selecting a template selection button 602.

Here, a text input window 704 for receiving text to be applied to a selected template from a user may be located at the bottom of the preview window 701.

In step 506, in the case of revising the basic text of the selected template (YES in step 506), the template provision unit 212 may receive desired text from a user through the text input window 704. For example, in the case of revising basic text, a user may select a template of an image to be applied and may type text a user wants to input into the text input window 704.

In step 507, the template provision unit 212 may combine an image of the selected template with the inputted text to generate a new template.

In at least one example embodiment, the template provision unit 212 may generate a new template, in which the template is combined with the inputted text, by changing the basic text included in an image of the selected template into the inputted text. For example, the first template 702 may be selected, and then “Don't do that” may be inputted in the text input window 704. Here, when a user selects an application button 705, the template provision unit 212 may generate a new template, by changing “Really?” included in an image of a speech bubble shape into “Don't do that”.

As such, when implemented in the form of in-app, the messenger service system may combine a template with text in a messenger app. However, the messenger service system may combine a template with text in an independent server connected to a user terminal through a messenger app. For example, when a user selects a template and inputs text to be applied, the user terminal may transmit identification information of an image, corresponding to a template selected through a messenger app, and the text to a server. Next, the server may search for a corresponding image in database thereof, based on the received identification information. After that, the server may generate a new template by combining the received text from the user terminal with the found image. The server may display the new template in a user terminal through a messenger app.

Still referring to FIG. 5, in step 508 when a user selects a transmission button 705, the template provision unit 212 may display the new template to users in the chat room.

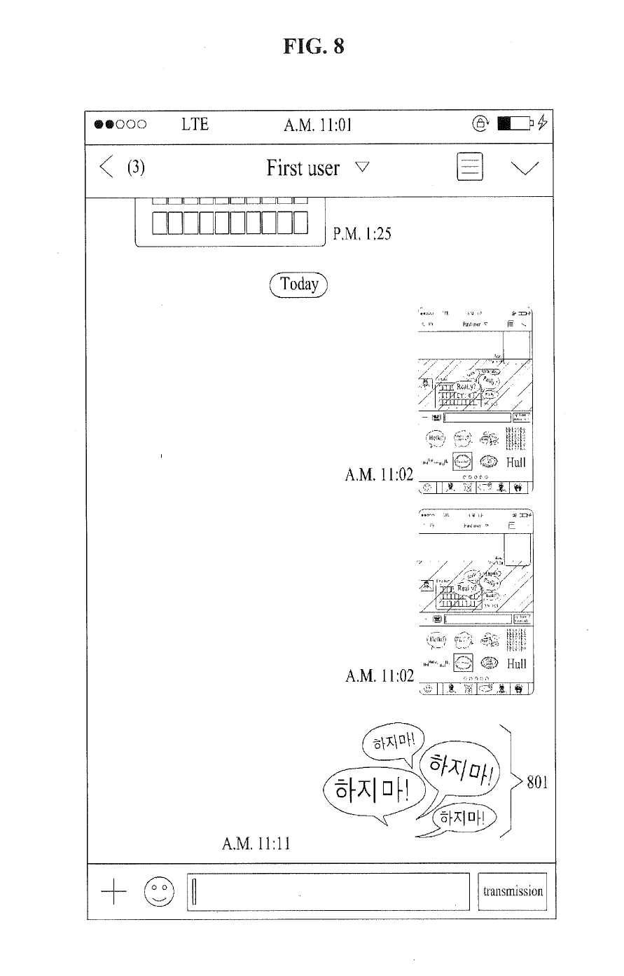

In at least one example embodiment, referring to FIG. 8, a new template 801 in which “Don't do that” inputted by a user is inserted in a speech bubble shape of a first template, and then displayed to users in the chat room. Here, the template provision unit 212 may combine “Don't do that” (the inputted text) with an identifier indicating an image of the first template, and may transmit the combined result to a terminal of each of the users in the chat room. Next, each terminal may extract the first template stored in advance from its storage medium (not shown) based on the identifier indicating an image of the first template. Moreover, each terminal may combine “Don't do that” (the inputted text) with the first extracted template and may display the combined result.

As such, when a user likes an image of a speech bubble shape, but dislikes the text of the image, the template provision unit 212 may select a template of an image a user wants, and provide a template suitable for a conversation situation in a chat room using a simple motion inputting the desired text.

Returning to step 506, when a user applies the basic text as it is without changing the basic text, in step 509 a first template may be displayed to users in a chat room by selecting the application or transmission button 705, with no text typed into the text input window 704.

In steps 506 to 509, when wanting to change a selected template or to cancel generation of a new template, a user may select a cancel button 706 displayed in a preview window 701. For example, when the cancel button 706 is selected, the preview window 701 may disappear and the template list window 603 including a plurality of templates may be displayed to a user terminal according to FIG. 6. Next, a user may select a desired template and may input text having desired contents. The template provision unit 212 may repeat an operation of steps 505 to 508 for generating a new template by combining inputted text with a selected template.

In FIGS. 5 to 8, an example embodiment of inventive concepts is illustrated with regard to the transmission button 705 and the application button 705 being implemented with the same button, and the application button is changed into the transmission button after being selected. However, the scope and spirit of inventive concepts should not be limited to this example. For example, the transmission button and the application button may be implemented with different buttons, respectively.

Moreover, in FIG. 5 above, an example embodiment of inventive concepts is illustrated with regard to a preview function being provided with respect to a selected template. However, the scope and spirit of inventive concepts should not be limited to this example. For example, the preview function may be provided with respect to a new template.

For example, in step 507, when a new template is generated, the template provision unit 212 may display the new template (e.g., a template in which “Don't do that” is combined with an image of a speech bubble shape) in the preview window 701. Here, when wanting to change the text a user inputs, the user may input new text to the text input window 704. In this case, the template provision unit 212 may combine an image of a speech bubble shape with the newly entered text to generate a new template and may display the new template in the preview window 701. For example, when “Stop” is inputted again, a template in which “Don't do that” is changed into “Stop” may be displayed again.

Here, there may be changed an image as well as text. For example, when disliking a new template obtained by applying “Don't do that” to a first template 702 displayed in the preview window 701, a user may again select a desired one of a plurality of templates displayed in the template list window 603.

For example, when a new template is displayed in a preview window 701 and a second template 707 is selected, the template provision unit 212 may regenerate a new template by combining an image of the second template 707 with “Don't do that” inputted in advance. Moreover, the template provision unit 212 may display the regenerated template (e.g., the second template 707 in which “Oh my god” is changed into “Don't do that”) in the preview window 701. Here, a server, rather than a messenger app, may regenerate a new template through re-inputting of text and reselecting of a template. The regeneration process may be the same or substantially the same as a template generation process, which is performed based on a combination of image identification information and text. Therefore, an overlapping operation may be omitted.

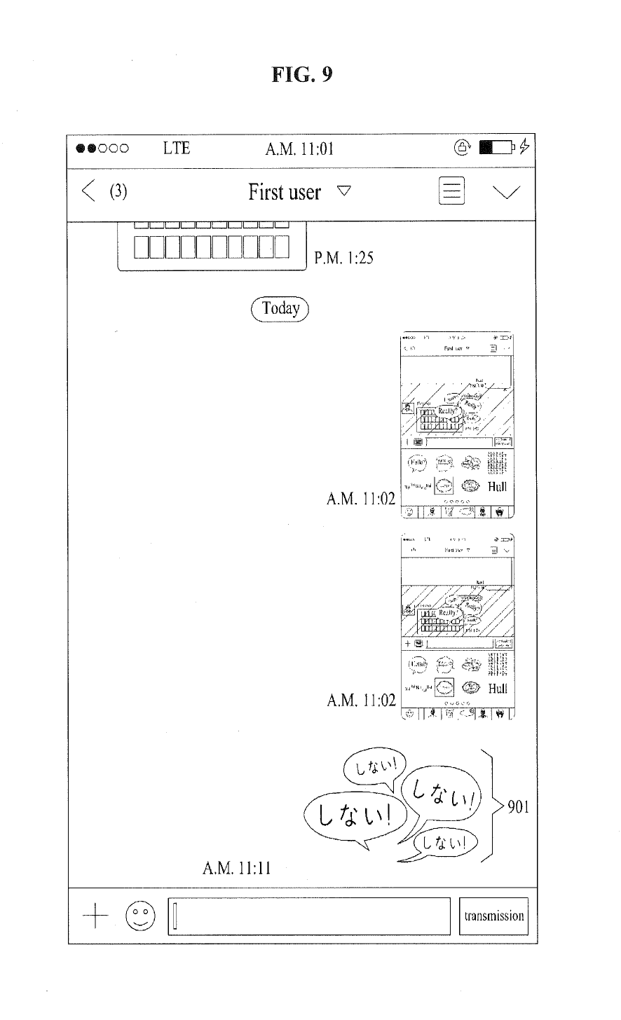

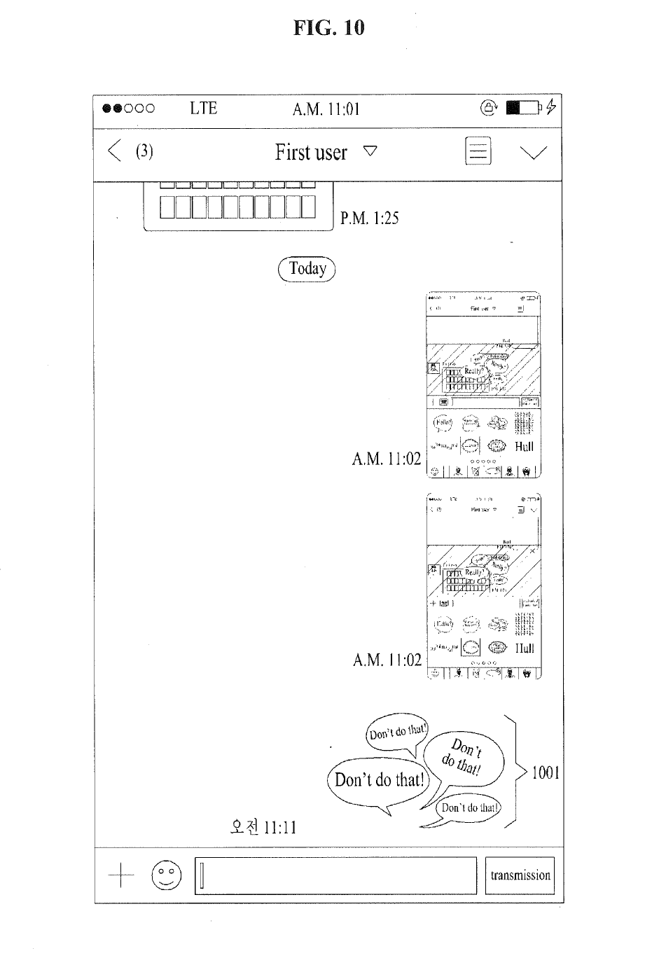

FIGS. 9 and 10 are diagrams illustrating screens for describing an operation for providing an automatic language translation function in generating a new template, according to an example embodiment of inventive concepts.

The template provision unit 212 may automatically translate text combined with a new template into a language of a country a user in a chat room belongs to, or a country in which a user in a chat room is connected to a messenger service in a chat room. Moreover, the template provision unit 212 may display a template, in which an automatically translated language is combined with an image, in a user terminal. Automatic language translation and generation of a new template in which the translated language is inserted may be performed in a messenger app of a user terminal, and may be performed in an independent server connected to a user terminal through a messenger app.

For example, when nationality of a first user who wants to generate a new template is Korean, “ [symbol] ” 801 of a speech bubble shape may be displayed in a terminal of the first as illustrated in FIG. 8. When nationality of a second user who talks to the first user in a chat room is Japanese, “ [symbol] ” 901 of a speech bubble shape may be displayed in a terminal of the second user as illustrated in FIG. 9. When nationality of a third user is American, “Don't do that!” 1001 of a speech bubble shape may be displayed in a terminal of the third user as illustrated in FIG. 10.

Example screens illustrated in FIGS. 6 to 10 may help understanding of the scope and spirit of inventive concepts. However, example embodiments should not be limited to these examples. A screen construction, a screen order, and the like, may be variously changed or modified.

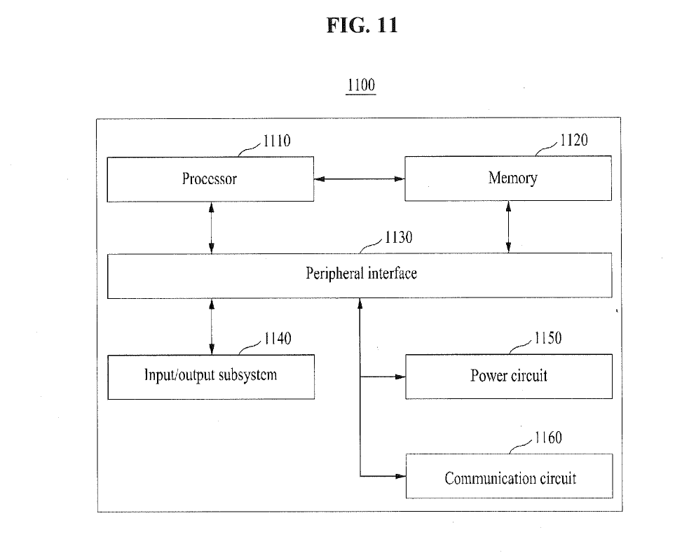

FIG. 11 is a block diagram schematically illustrating an example internal configuration of a computer system according to an example embodiment of inventive concepts.

As illustrated in FIG. 11, a computer system 1100 may include at least one processor 1110, a memory 1120, a peripheral interface 1130, an input/output subsystem 1140, a power circuit 1150, and a communication circuit 1160. Here, the computer system 1100 may correspond to a user terminal.

For example, the memory 1120 may include a high-speed random access memory (RAM), a magnetic disc, a static RAM, a dynamic RAM, a read only memory (ROM), a flash memory, or a nonvolatile memory. The memory 1120 may include a software module, a command set, or a variety of data necessary for an operation of the computer system. The processor 1110 may control an access to the memory 1120 from the processor 1110 or any other component (e.g., the peripheral interface 1130).

The peripheral interface 1130 may couple a peripheral input and/or output device of the computer system 1100 to the processor 1110 and the memory 1120. The processor 1110 may execute a software module or a command set stored at the memory 1120 to perform a variety of functions for the computer system 1100 and to process data.

The input/output subsystem 1140 may couple a variety of peripheral input/output devices to the peripheral interface 1130. For example, the input/output subsystem 1140 may include a controller for coupling a monitor, a keyboard, a mouse, a printer, or a peripheral device, such as a touch screen or a sensor, to the peripheral interface 1130. According to another aspect, peripheral input/output devices may be coupled to the peripheral interface 1130 without passing through the input/output subsystem 1140.

All or a part of components of a terminal may be powered by the power circuit 1150. For example, the power circuit 1150 may include a power management system, one or more power sources such as a battery or an alternating current (AC), a charging system, a power failure detection circuit, a power converter or inverter, a power status indicator, or any other components for power generation, management, and distribution.

The communication circuit 1160 may communicate with other computer system using at least one external port. As described above, the communication circuit 1160 may include a RF circuit and may communicate with other computer system by transmitting and receiving an RF signal known as an electromagnetic signal.

The computer system 1100 illustrated in FIG. 11 may be example. The computer system 1100 may not include some of components illustrated in FIG. 11, may further include components not illustrated in FIG. 11, or may be implemented such that two or more components are combined. For example, the computer system 1100 for a mobile terminal of a communication environment may include a touch screen, a sensor, and the like as well as components illustrated in FIG. 11, and the communication 1160 may include circuits for RF communications such as wireless-fidelity (Wi-Fi), 3G, long term evolution (LTE), Bluetooth, near field communication (NFC), Zigbee, and the like. Components capable of being included in the computer system 1100 may be implemented with hardware, including an integrated circuit specialized for one or more signal processing or an application, software, or a combination thereof.

Methods according to one or more example embodiments of inventive concepts may be implemented in the format of program instruction executable through various computer systems and may be recorded at a computer-readable medium. In particular, a program according to one or more example embodiments of inventive concepts may be a PC-based program or an application dedicated to a mobile terminal. A messenger application to which one or more example embodiments of inventive concepts is applied may be installed on a user terminal through a file which a file distribution system provides. For example, the file distribution system may include a file transfer unit (not illustrated), which transfers the file in response to a request of a user terminal.

The aforementioned messenger service methods, according to one or more example embodiments, may include shortened operations or additional operations based on details of a messenger service system described with reference to FIGS. 1 to 10. Moreover, two or more operations may be combined and an order or a position of operations may be changed.

As such, according to one or more example embodiments of inventive concepts, when a user selects one of a template of a speech bubble shape, a template of a sticker shape, and a template of an emoticon, and an image of the selected template does not include text a user wants, a new template suitable for a conversation flow may be provided by simply inputting text in a text window by the user. Moreover, one or more example embodiments of inventive concepts may improve user convenience of messengers and/or provide services different from existing services, as well as a high-quality services, by automatically translating text a user inputs into a language of a corresponding country based on nationality of a user in a chat room, or a country in which a user is connected to a messenger service.

The units (or devices) described herein may be implemented using hardware components, software components, and/or a combination thereof. For example, devices and components described therein may be implemented using processing circuitry such as, but not limited to, a processor, a controller, an arithmetic logic unit (ALU), a digital signal processor, a microcomputer, a field programmable gate array (FPGA), a programmable logic unit, a microprocessor or any other device capable of responding to and executing instructions in a defined manner. The processing circuitry and/or hardware devices (also sometimes referred to herein as a processing device) may be configured as special purpose processing circuitry and/or hardware devices to perform functions illustrated in one or more of the flow charts or sequence diagrams discussed herein.

A processing device may run an operating system (OS) and one or more software applications that run on the OS. The processing device also may access, store, manipulate, process, and create data in response to execution of the software. For the sake of easy understanding, one or more example embodiments of inventive concepts is/are exemplified as one processing device is used; however, one skilled in the art will appreciate that a processing device may include multiple processing elements and multiple types of processing elements. For example, a processing device may include multiple processors or a processor and a controller. In addition, other processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

Methods according to one or more example embodiments may be implemented in the format of program instruction executable through various computing devices and may be recorded in a non-transitory computer-readable storage medium. The computer-readable medium may also include program instructions, data files, data structures, and the like independently or in the format of combination. The program instructions recorded in the medium may be those specially designed and constructed for the embodiment or may be well-known and available to those skilled in the computer software arts. Examples of the computer-readable medium may include magnetic media such as hard disks, floppy disks, and magnetic tape; optical media such as CD ROM disks and DVD; magneto-optical media such as floptical disks; and hardware devices that are specialized to store and perform program instructions, such as read-only memory (ROM), random access memory (RAM), flash memory, and the like. Examples of program instructions may include both machine code produced by a compiler and high-level code executed by the computer using an interpreter. The described hardware devices may be configured to operate as one or more modules or units to perform the operations of the above-described example embodiments, and vice versa.

One or more example embodiments of inventive concepts may provide messenger services by receiving text a user wants and combining a template image a user selects with the text, when a user likes the template image, but dislikes the text applied to the template.

Although described with reference to specific examples and drawings, modifications, additions and substitutions on example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

While inventive concepts has been described with reference to example embodiments, it will be apparent to those skilled in the art that various changes and modifications may be made without departing from the spirit and scope of inventive concepts. Therefore, it should be understood that the above embodiments are not limiting, but illustrative.

What is claimed is:

1. A messenger service method for implementing communications between a first terminal and a second terminal, the messenger service method comprising:
selecting one of a plurality of templates at the first terminal;
receiving text from a user of the first terminal;
combining the received text with the selected one of the plurality of templates to generate a modified template including the received text;
displaying the modified template; and
transmitting the modified template to the second terminal.

2. The messenger service method of claim 1, further comprising:
transmitting the modified template to a third terminal in response to receiving confirmation, from the user, that the modified template should be transmitted to the third terminal.

3. The messenger service method of claim 1, wherein the transmitting comprises:
transmitting, to the second terminal, an identifier identifying the received text and the selected one of the plurality of templates.

4. The messenger service method of claim 1, wherein the selected one of the plurality of templates includes at least one of an emoticon used in the messenger service, an image of a sticker shape, and an image of a speech bubble shape.

5. The messenger service method of claim 1, further comprising:
automatically translating the received text combined with the selected one of the plurality of templates into a language of a country to which a user of the second terminal belongs; and wherein
the combining combines the selected one of the plurality templates with the translated text to generate the modified template.

6. The messenger service method of claim 1, wherein the combining comprises:
changing a basic text portion of the selected one of the plurality of templates into the received text from the user, while maintaining an image portion of the selected one of the plurality of templates, to generate the modified template.

7. The messenger service method of claim 1, further comprising:
changing at least one of the received text and the selected one of the plurality of templates, which are displayed as the modified template.

8. The messenger service method of claim 1, further comprising:
displaying, at the second terminal, the modified template including the received text.

9. The messenger service method of claim 1, further comprising:
involving the second terminal in a chat room; and
providing one or more of the plurality of templates stored at the first terminal to the user in advance of the selecting the one or more of the plurality of templates.

10. A non-transitory computer-readable storage medium including computer-executable instructions that, when executed, cause a computer system to provide a messenger service method for implementing communications between a first terminal and a second terminal, the messenger service method comprising:
selecting one of a plurality of templates at the first terminal;
receiving text from a user of the first terminal;
combining the received text with the selected one of the plurality of templates to generate a modified template including the received text;
displaying the modified template; and
transmitting the modified template to the second terminal.

11. The non-transitory computer-readable storage medium of claim 10, wherein the messenger service method further comprises:
involving the second terminal in a chat room; and
providing one or more of the plurality of templates stored at the first terminal to the user in advance of the selecting the one or more of the plurality of templates.

12. A messenger service system for implementing communications between a first terminal and a second terminal, the messenger service system comprising:
a memory having computer-readable instructions stored therein; and
at least one processor configured to execute the computer-readable instructions to
generate a modified template by combining text received from a user of the first terminal with a template selected from among a plurality of templates by the user of the first terminal, and
transmit the modified template to the second terminal.

13. The messenger service of claim 12, wherein the at least one processor is further configured to provide the messenger service to involve the second terminal in a chat room, and to provide one or more of a plurality of stored templates stored at the first terminal to the user of the first terminal prior to selection of the template by the user of the first terminal.

14. The messenger service system of claim 12, wherein the at least one processor is further configured to transmit the modified template to a third terminal in response to receiving confirmation, from the user of the first terminal, that the modified template should be transmitted to the third terminal.

15. The messenger service system of claim 12, wherein the at least one processor is further configured to transmit, to the second terminal, an identifier identifying the received text and the selected template.

16. The messenger service system of claim 12, wherein the selected template includes at least one of an emoticon used in the messenger service, an image of a sticker shape, and an image of a speech bubble shape.

17. The messenger service system of claim 12, wherein the at least one processor is further configured to
automatically translate the received text combined with the selected template into a language of a country to which a user of the second terminal belongs, and
combine the selected template with the translated text to generate the modified template.

18. The messenger service system of claim 12, wherein the at least one processor is further configured to change a basic text portion of the selected template into the received text from the user, while maintaining an image portion of the selected template, to generate the modified template.

19. The messenger service system of claim 12, wherein the at least one processor is further configured to
display the modified template at the first terminal; and
change at least one of the selected template and the received text, which are displayed as the modified template.
